(19) United States
(12) Patent Application Publication
(10) Pub. No.: US 2019/0293987 A1
(43) Pub. Date: Sep. 26, 2019

(54) DISPLAY APPARATUS

(71) Applicant: Mitsubishi Electric Corporation, Tokyo (JP)

(72) Inventor: Hiroki AKATSUKA, Tokyo (JP)

(73) Assignee: Mitsubishi Electric Corporation, Tokyo (JP)

(21) Appl. No.: 16/347,945

(22) PCT Filed: Dec. 12, 2016
(86) PCT No.: PCT/JP2016/086902

§ 371 Date: May 7, 2019

(51) Int. Cl. G02F 1/1333

(52) U.S. Cl. CPC G02F 1/133308; G02F 2001/13332; G02B 6/0088; G02F 2001/133331; G02F 2001/133314; G02F 2001/133317

(57) ABSTRACT

A protective plate (30) is provided in an opening (20) of a design bezel (2). The design bezel (2) includes ribs (22) rising from a back surface thereof around the opening (20). A shrinkage suppressing member (4) provided behind a display module (3) is sandwiched between the ribs (22) at sides of the shrinkage suppressing member (4), and has rigidity that prevents deformation even when the shrinkage suppressing member (4) receives a force in a shrinking direction from the design bezel (2) and a linear expansion coefficient smaller than a linear expansion coefficient of the design bezel (2).

### TECHNICAL FIELD

The present invention relates to a display apparatus in which a protective plate is provided in an opening of a design bezel.

### BACKGROUND ART

For example, Patent Literature 1 describes a display apparatus including a bezel of a rectangular frame shape at the front edge of a liquid crystal display panel. In the related art, there is a case where a transparent protective plate is further provided on the front surface of a liquid crystal display panel for the purpose of protection against external impact or the like, improvement of design, improvement of optical characteristics, and so on. In this case, the protective plate is provided in an opening of a design bezel, and a seamless design, in which the protective plate and the design bezel of a rectangular frame shape are provided without a step nor a gap, is preferred.

### CITATION LIST

### Patent Literature

Patent Literature 1: JP 2006-106417 A

### SUMMARY OF INVENTION

### Technical Problem

However, in the case where the protective plate and the design bezel are made of different materials, when the ambient temperature drops and the two shrink, a difference occurs in the degree of shrinkage due to a difference in the linear expansion coefficient. For example, protective plates are often made of glass, and design bezels are made of resin in many cases. Glass has a low linear expansion coefficient, whereas resin has a large linear expansion coefficient. That is, when a protective plate and a design bezel shrink, the protective plate has a small degree of shrinkage, whereas the design bezel has a large degree of shrinkage. Therefore, in the case where a gap between the protective plate and the design bezel is small, the protective plate and the design bezel come into contact, thereby generating stress around the contact point. In particular, a large stress is generated around the four corners of the opening of the design bezel, which may result in a crack on the front surface that is the design surface of the design bezel.

The present invention has been devised in order to solve the problem as above, and an object of the present invention is to obtain a display apparatus less prone to cracks on a front surface of a design bezel.

### Solution to Problem

A display apparatus according to the present invention includes: a design bezel including an opening which penetrates through a front surface and a back surface of the design bezel and one or more ribs raised from the back surface around the opening; a display module including a protective plate provided in the opening, the display module provided behind the design bezel; and a shrinkage suppressing member provided behind the display module, in which the shrinkage suppressing member is sandwiched between the ribs at sides of the shrinkage suppressing member, and has rigidity that prevents deformation even when the shrinkage suppressing member receives a force in a shrinking direction from the design bezel and a linear expansion coefficient smaller than a linear expansion coefficient of the design bezel.

### Advantageous Effects of Invention

According to the present invention, the ribs rise from the back surface of the design bezel, and the shrinkage suppressing member, having rigidity that prevents deformation even when the shrinkage suppressing member receives a force in the shrinking direction from the design bezel and a linear expansion coefficient that is smaller than the linear expansion coefficient of the design bezel, is sandwiched between the ribs at the sides. Thus, cracks are unlikely to occur on the front surface of the design bezel.

### BRIEF DESCRIPTION OF DRAWINGS

FIG. 1 is an overall perspective view of a display apparatus according to a first embodiment of the present invention.

FIG. 2 is an exploded perspective view of the display apparatus according to the first embodiment of the present invention.

FIG. 3 is an exploded perspective view of the display apparatus according to the first embodiment of the present invention.

FIG. 4 is a plan view of a design bezel.

FIG. 5 is an enlarged view of a portion A of FIG. 3.

FIG. 6 is a cross-sectional view of the display apparatus according to the first embodiment of the present invention.

FIG. 7 is an exploded perspective view of a display apparatus which is a reference example.

FIG. 8 is a plan view of a design bezel included in the display apparatus which is a reference example.

FIG. 9 is a cross-sectional view of the display apparatus which is a reference example.

FIG. 10 is a cross-sectional view illustrating a modification of the display apparatus according to the first embodiment of the present invention.

FIG. 11 is a plan view illustrating a modification of a rib.

FIG. 12 is a plan view of a display module.

FIG. 13 is an exploded perspective view of the display module.

FIG. 14 is a cross-sectional view of the display module.

FIG. 15 is a cross-sectional view illustrating a state in which the display module, ideally assembled, and the design bezel are assembled.

FIG. 16 is an exploded perspective view of a display apparatus according to a second embodiment of the present invention.

FIG. 17 is a cross-sectional view of the display apparatus according to the second embodiment of the present invention.

FIG. 18 is an exploded perspective view illustrating a modification of the display apparatus according to the second embodiment of the present invention.

FIG. 19 is a cross-sectional view illustrating a modification of the display apparatus according to the second embodiment of the present invention.

### DESCRIPTION OF EMBODIMENTS

To describe the present invention further in detail, embodiments for carrying out the present invention will be described below with reference to the accompanying drawings.

### First Embodiment

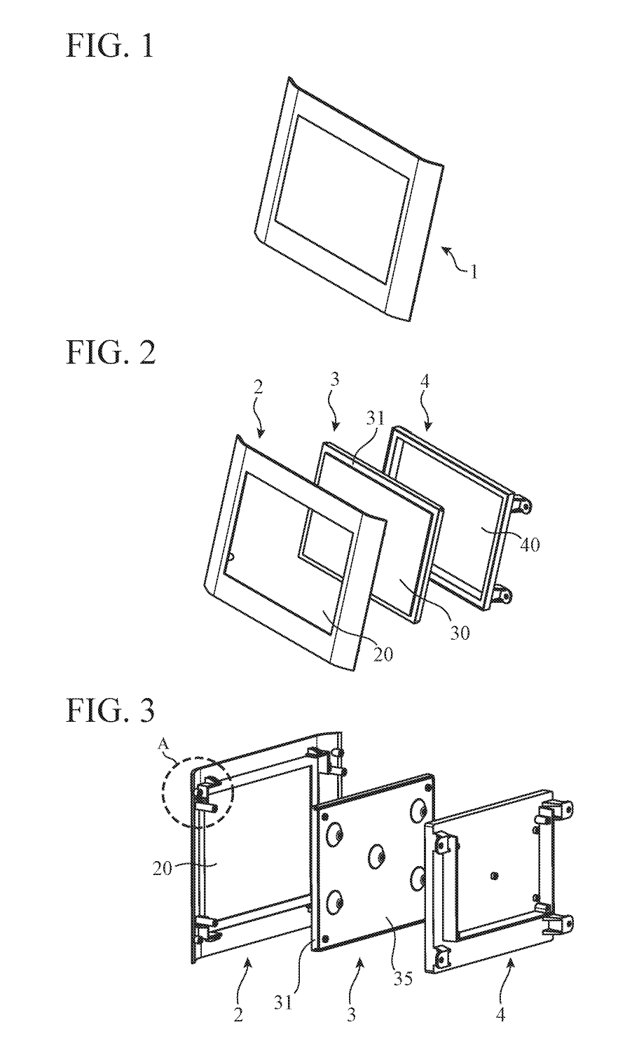

FIG. 1 is an overall perspective view of a display apparatus 1 according to a first embodiment of the present invention. FIGS. 2 and 3 are exploded perspective views of the display apparatus 1. FIG. 2 is an exploded perspective view of the display apparatus 1 as viewed from the front, and FIG. 3 is an exploded perspective view of the display apparatus 1 as viewed from the rear. The front refers to the direction in which a user viewing a display of the display apparatus 1 is present as viewed from the display apparatus 1. The rear refers to the direction opposite to the front as viewed from the display apparatus 1. In addition, the direction that is substantially orthogonal to the front and the rear is referred to as the side. The display apparatus 1 is used as, for example, an in-vehicle display apparatus, and includes a design bezel 2, a display module 3, and a shrinkage suppressing member 4.

The display module 3 is provided behind the design bezel 2, and the shrinkage suppressing member 4 is provided behind the display module 3.

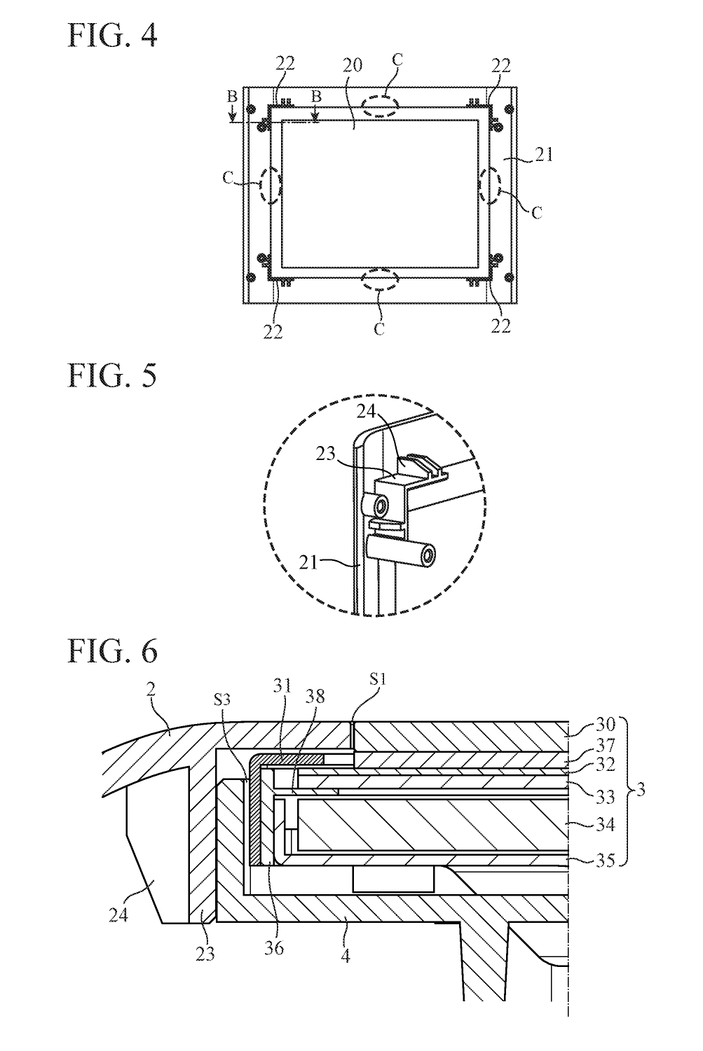

The design bezel 2 has a substantially rectangular frame shape and has, substantially at the center thereof, an opening 20 which penetrates through the front surface and the back surface of the design bezel 2. A display surface of the display module 3 is exposed from the opening 20. FIG. 4 is a plan view of the design bezel 2 as viewed from the rear. Around the opening 20 formed by a frame main body 21 having a substantially rectangular frame shape, four ribs 22 each rise from the back surface of the design bezel 2. The four ribs 22 of the design bezel 2 are provided around the respective four corners of the opening 20 having a rectangular shape in a plan view. Here, the rectangular shape in a plan view includes a substantially rectangular shape in a plan view. The display module 3 and the shrinkage suppressing member 4 are accommodated in a space having a rectangular shape in a plan view surrounded by the four ribs 22.

FIG. 5 is a perspective view illustrating the rib 22. FIG. 5 corresponds to an enlarged portion A from FIG. 3. The rib 22 has an abutment wall 23 rising from the back surface of the design bezel 2 in a substantially L-letter shape in a plan view. As illustrated in FIG. 6 which will be described later, the inner surface of the abutment wall 23 is in contact with the shrinkage suppressing member 4. The rib 22 also has four support walls 24 rising from the back surface of the design bezel 2 and intersecting with the outer surface of the abutment wall 23 at a substantially right angle.

The design bezel 2 is made of resin, for example, and the four ribs 22 are formed integrally with the frame main body 21.

The display module 3 includes a protective plate 30 at the foremost side and is a plate-shaped member which has a rectangular shape in a plan view and in which a touch panel 32 which will be described later, a liquid crystal panel 33 which will be described later, an optical member 34 which will be described later, a metal member 35 which will be described later, and other members are modularized by a cover sheet metal 31 having a substantially rectangular frame shape and also serving as an electrostatic countermeasure. The protective plate 30 has a linear expansion coefficient smaller than that of the design bezel 2, and is made of, for example, glass.

The shrinkage suppressing member 4 is a container-like member having a rectangular shape in a plan view and having a space 40 opened toward the front. In the space 40, the display module 3 is housed. The shrinkage suppressing member 4 is made of a metal such as aluminum and has, as will be described later, rigidity that prevents deformation even when the shrinkage suppressing member 4 receives a force in the shrinking direction from the design bezel 2 and a linear expansion coefficient that is smaller than the linear expansion coefficient of the design bezel 2.

FIG. 6 is a cross-sectional view when the design bezel 2, the display module 3, and the shrinkage suppressing member 4 are assembled into the display apparatus 1. FIG. 6 corresponds to a part where the display apparatus 1 including the design bezel 2 is cut at the position of a cutting line B-B illustrated in FIG. 4.

The display module 3 includes the protective plate 30, the cover sheet metal 31, the touch panel 32, the liquid crystal panel 33, the optical member 34, the metal member 35, and a resin frame 36.

The protective plate 30 and the touch panel 32 are bonded by a transparent adhesive layer 37. Note that, although not illustrated, a transparent adhesive layer similar to the transparent adhesive layer 37 is provided between the touch panel 32 and the liquid crystal panel 33.

Behind the liquid crystal panel 33, the optical member 34 is provided while a rib 38 extending from the resin frame 36 is interposed therebetween. The optical member 34 includes a light guide plate, an optical sheet, and other components. The metal member 35 is made of aluminum, for example, and is provided so as to cover the back surface and the side surfaces of the optical member 34. The metal member 35 serves as a lid for the display module 3 and also promotes heat radiation.

Although not illustrated, a light emitting body such as a light emitting diode (LED) is provided on the side of the light guide plate of the optical member 34, and light emitted from the light emitting body illuminates the liquid crystal panel 33.

In the assembled state of the display apparatus 1, the protective plate 30 of the display module 3 is provided in the opening 20 of the design bezel 2. Furthermore, in the assembled state of the display apparatus 1, the rear of the display module 3 is covered with the shrinkage suppressing member 4. In this state, the protective plate 30 is provided leaving a small gap S1 from the edge of the opening 20 of the design bezel 2. In addition, the shrinkage suppressing member 4 is in contact with the inner surfaces of the abutment walls 23 of the respective ribs 22 and thereby is lightly press-fitted while sandwiched between the four ribs 22 at the sides of the four corners of the shrinkage suppressing member 4.

When the ambient temperature of the display apparatus 1 drops, each member of the display apparatus 1 shrinks. At that time, the design bezel 2 made of, for example, resin and the protective plate 30 made of, for example, glass are to shrink at different degrees of shrinkage. Specifically, the design bezel 2 made of resin is to shrink more than the protective plate 30 made of glass does.

Meanwhile, the shrinkage suppressing member 4 has rigidity that prevents deformation even when the shrinkage suppressing member 4 receives a force in the shrinking direction from the design bezel 2 which is to shrink due to a decrease in temperature, and the shrinkage suppressing member 4 has a linear expansion coefficient that is smaller than the linear expansion coefficient of the design bezel 2. Moreover, in the design bezel 2, the inner surfaces of the respective ribs 22 are in contact with the shrinkage suppressing member 4. Therefore, the shrinkage of the design bezel 2 is suppressed by the shrinkage suppressing member 4.

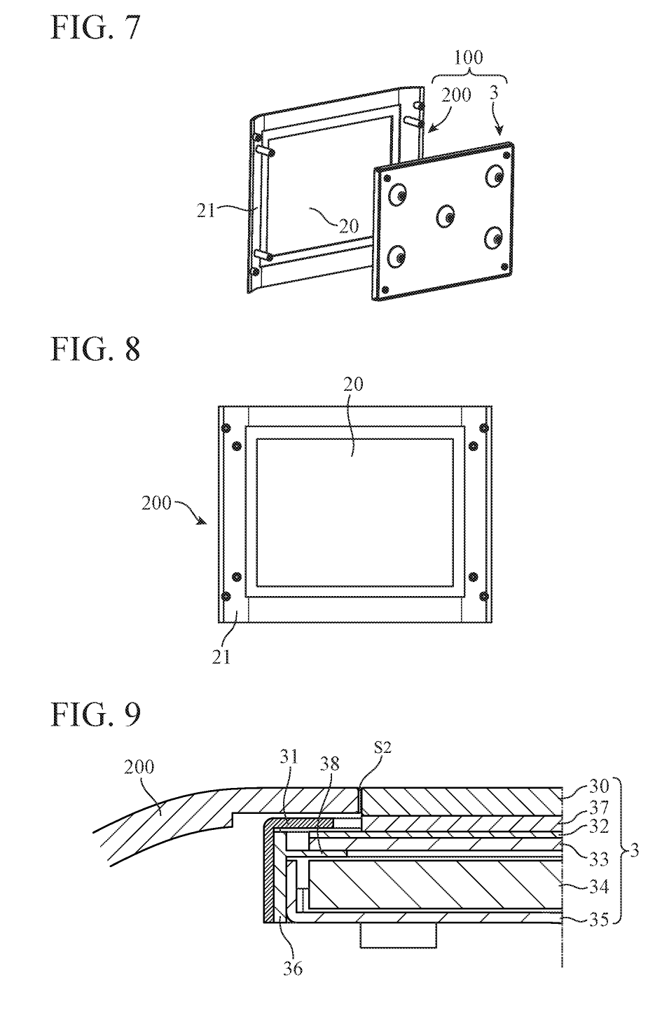

Here, FIGS. 7, 8, and 9 illustrate a reference example as an aid for understanding of the display apparatus 1 according to the first embodiment of the present invention. FIG. 7 is an exploded perspective view of a display apparatus 100 which is a reference example. FIG. 8 is a plan view of a design bezel 200 of the display apparatus 100 as a reference example, as viewed from the rear. FIG. 9 is a cross-sectional view of the display apparatus 100 as a reference example. Note that in FIGS. 7, 8, and 9, the same reference numerals are given to the same parts as or corresponding parts to those in FIGS. 1 to 6, and the description thereof will be omitted or simplified.

The display apparatus 100 includes the design bezel 200 and a display module 3, but unlike the display apparatus 1, no shrinkage suppressing member 4 is included. The design bezel 200 includes a frame main body 21 having a substantially rectangular frame shape, but unlike the design bezel 2, no ribs 22 are included. Like the design bezel 2, the design bezel 200 is made of resin, for example.

As illustrated in FIG. 9, in the display apparatus 100, a protective plate 30 is provided leaving a small gap S2 from the edge of an opening 20 of the design bezel 200.

In the display apparatus 100, when the ambient temperature drops, the design bezel 200 starts to shrink without being stopped by the ribs 22 or the shrinkage suppressing member 4. Since the design bezel 200 made of resin shrinks more than the protective plate 30 made of glass, the design bezel 200 eventually comes into contact with the side surfaces of the protective plate 30. When this happens, large stress occurs particularly around the four corners of the opening 20 of the design bezel 200, and thus cracks occur around the four corners of the opening 20 on the front surface and the back surface of the design bezel 200. In addition, the protective plate 30 warps by receiving the force in the shrinking direction from the design bezel 200, thus resulting in display unevenness.

On the other hand, in the display apparatus 1 according to the first embodiment, since the ribs 22 and the shrinkage suppressing member 4 suppress the shrinkage of the design bezel 2, the gap S1 between the protective plate 30 and the edge of the opening 20 of the design bezel 2 is maintained. Therefore, it is possible to suppress the occurrence of stress around the four corners of the opening 20 of the design bezel 2, which can prevent cracks on the front surface that is the design surface of the design bezel 2. In addition, warping of the protective plate 30 is also suppressed, and thus display unevenness is unlikely to occur.

In addition to suppressing the shrinkage of the design bezel 2, the shrinkage suppressing member 4 promotes heat radiation of the display module 3, protects the display module 3, and functions as an electromagnetic shield.

In addition, designing the dimensions so that a gap S3 is formed between the display module 3 and the shrinkage suppressing member 4 as illustrated in FIG. 6 allows the gap S1 between the protective plate 30 and the edge of the opening 20 of the design bezel 2 to be small and allows the shrinkage suppressing member 4 to be easily assembled to the ribs 22 in a lightly press-fitted manner even in the case where there is a tolerance or the like in each of the members of the display apparatus 1.

Note that, in the above description, the display apparatus 1 performs display by the liquid crystal method; however, the display apparatus 1 may perform display by the organic electro luminescence (EL) method, the plasma method, or other methods.

Moreover, the shrinkage suppressing member 4 is only required to have rigidity that prevents deformation even when the shrinkage suppressing member 4 receives a force in the shrinking direction from the design bezel 2 and a linear expansion coefficient that is smaller than the linear expansion coefficient of the design bezel 2, and thus the shrinkage suppressing member 4 may be made of resin containing glass filler, resin containing carbon filler, or the like. From the viewpoint of promoting heat radiation of the display module 3, it is more preferable that carbon filler is contained. In addition to being smaller than the linear expansion coefficient of the design bezel 2, it is further preferable that the linear expansion coefficient of the shrinkage suppressing member 4 is close to the linear expansion coefficient of the protective plate 30. In the case where the linear expansion coefficient of the shrinkage suppressing member 4 and the linear expansion coefficient of the protective plate 30 are close to each other, the gap S1 between the protective plate 30 and the edge of the opening 20 of the design bezel 2 is maintained at a substantially constant width before and after shrinkage, which is preferable from the viewpoint of design.

In addition, the number and positions of the ribs 22 are not limited to those illustrated in the figures as long as the ribs 22 sandwich the shrinkage suppressing member 4 at the sides of the shrinkage suppressing member 4 to suppress the shrinkage of the design bezel 2.

For example, in addition to the four ribs 22 provided at the four corners as illustrated in the figure, ribs 22 may be provided at the central parts C illustrated in FIG. 4. With this structure, shrinkage of the design bezel 2 can be further suppressed.

Alternatively, for example, one annular rib surrounding the entire circumference of the opening 20 may be provided. In this case, the opening 20 may have various shapes such as a substantially oval shape in a plan view.

In addition, as illustrated in a second embodiment which will be described later, a display panel 3A and a backlight 3B may not be modularized as the display module 3 but be assembled to the design bezel 2 as separate members.

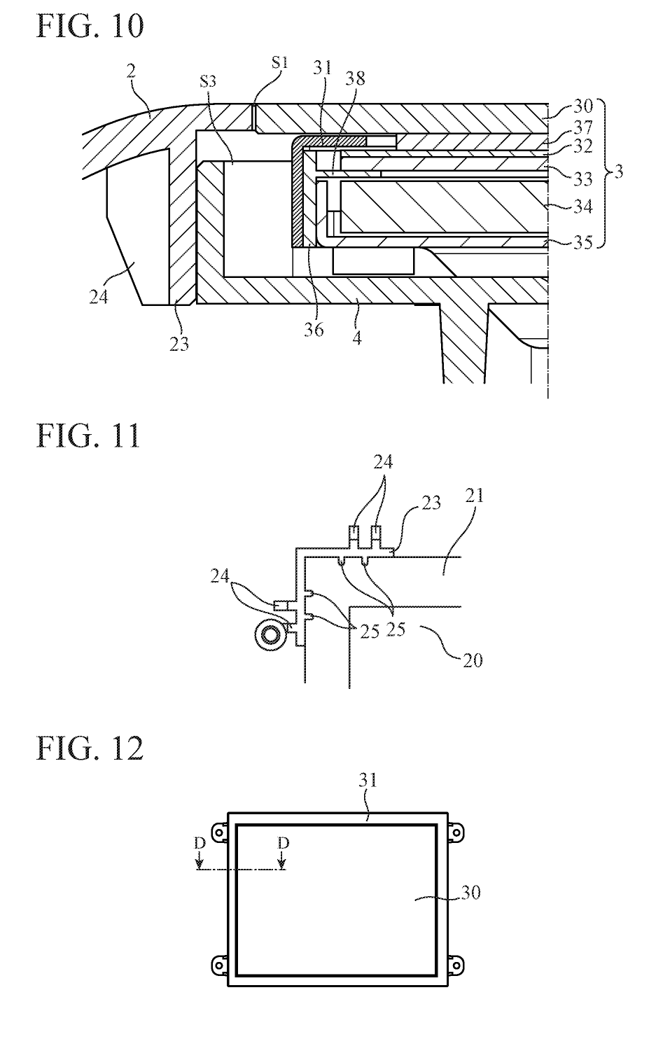

In the display module 3, relative sizes of the protective plate 30 and other members may vary. In FIG. 6, the outer shape of the protective plate 30 is smaller than the outer shape of the liquid crystal panel 33 and other members. However, as illustrated in FIG. 10, the outer shape of the protective plate 30 may be larger than the outer shape of the liquid crystal panel 33 and other members.

Further alternatively, as illustrated in FIG. 11, four thin ribs 25 may be further provided on the inner surfaces of the respective ribs 22 to allow the shrinkage suppressing member 4 to be in contact with the thin ribs 25 and thereby lightly press-fitted.

As described above, according to the display apparatus 1 of the first embodiment of the present invention, the ribs 22 are provided on the back surface of the design bezel 2, and the shrinkage suppressing member 4, having rigidity that prevents deformation even when the shrinkage suppressing member 4 receives a force in the shrinking direction from the design bezel 2 and a linear expansion coefficient that is smaller than the linear expansion coefficient of the design bezel 2, is sandwiched between the ribs 22 at the sides of the shrinkage suppressing member 4. Therefore, cracks are unlikely to occur on the front surface of the design bezel 2.

Furthermore, each of the ribs 22 is provided around the corresponding one of the four corners of the opening 20 having a rectangular shape in a plan view, and the shrinkage suppressing member 4 is sandwiched between the ribs 22 at the sides of the four corners of the shrinkage suppressing member 4. By providing the ribs 22 at positions where a particularly large stress is generated, it is possible to effectively prevent cracks from occurring.

### Second Embodiment

In the first embodiment, the case where the shrinkage suppressing member 4 for suppressing shrinkage of the design bezel 2 is a member separate from the display module 3 has been described. In the second embodiment, a case where a member corresponding to the metal member 35 of the display module 3 in the first embodiment is used as a shrinkage suppressing member will be described. Note that the same reference numerals are given to components having the same functions as or corresponding functions to those of components already described in the first embodiment, and description thereof will be omitted or simplified.

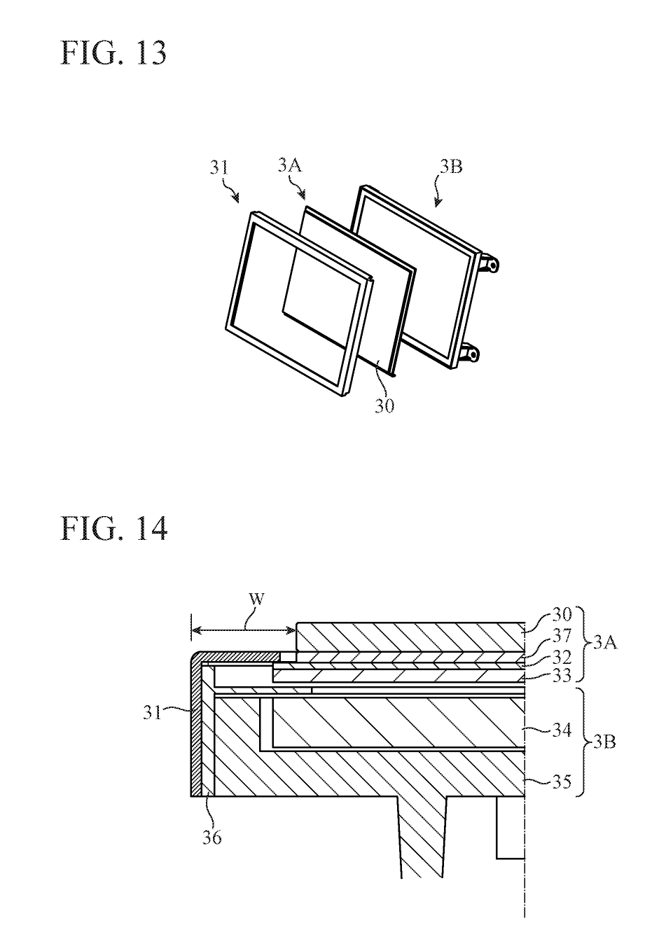

FIG. 12 is a plan view of a display module viewed from the front, the display module including a cover sheet metal 31, a display panel 3A, and a backlight 3B. FIG. 13 is an exploded perspective view of the display module of FIG. 12. FIG. 14 is a cross-sectional view when the display module of FIG. 12 is cut at the position of a cutting line D-D illustrated in FIG. 12.

The display panel 3A includes a protective plate 30, a touch panel 32, and a liquid crystal panel 33.

The backlight 3B includes an optical member 34, a metal member 35, and a resin frame 36. Like the shrinkage suppressing member 4 of the first embodiment, the metal member 35 has rigidity that prevents deformation even when the metal member 35 receives a force in the shrinking direction from a design bezel 2 and a linear expansion coefficient that is smaller than the linear expansion coefficient of the design bezel 2.

In the case where the display module is structured as in the first embodiment, for example, the display panel 3A, the backlight 3B, and the cover sheet metal 31 are assembled in advance into a module, and then a display apparatus 1a is assembled. However, at that time, the positional relationship between the display panel 3A and the backlight 3B varies due to the tolerance of each of the members included in the display module and the assembling errors at the time of modularization. For this reason, a distance W in FIG. 14 varies.

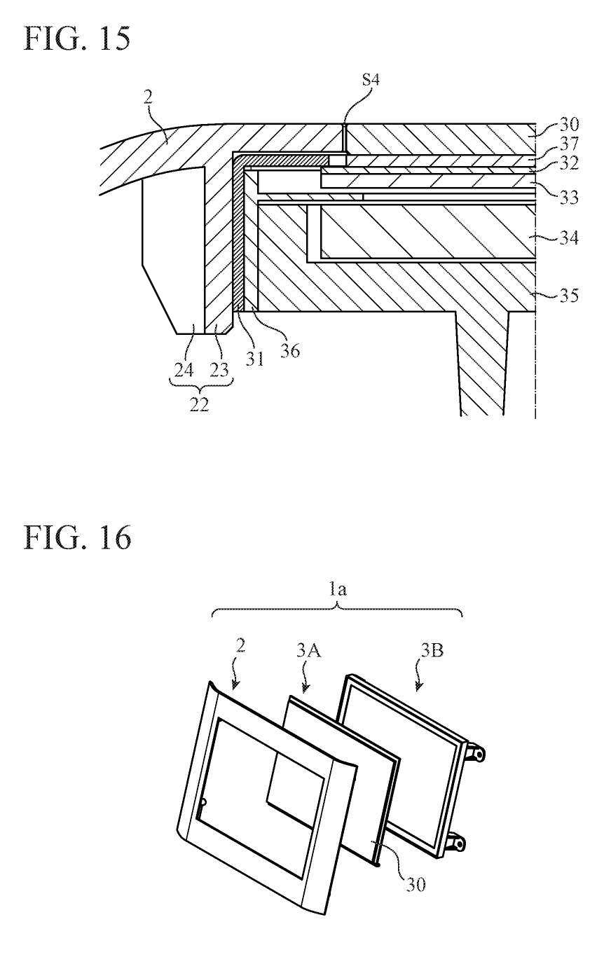

Here, FIG. 15 is a cross-sectional view illustrating a state where the display module in which the members are assembled in an ideal positional relationship and the design bezel 2 are assembled. In this case, the distance W has an ideal value. Thus, the protective plate 30 is assembled at a position which allows a gap S4 from an edge of an opening 20 of the design bezel 2 to have a preferably small dimension from the design aspect, and the cover sheet metal 31 is assembled at a position which allows the cover sheet metal 31 to come into contact with ribs 22 to be lightly press-fitted. Since the metal member 35, having rigidity that prevents deformation even when the metal member 35 receives a force in the shrinking direction from the design bezel 2 and a linear expansion coefficient that is smaller than the linear expansion coefficient of the design bezel 2, is sandwiched between the ribs 22 at the sides, shrinkage of the design bezel 2 is suppressed.

However, since in the reality the distance W varies as described above, it is difficult to assemble in such a manner as to allow the gap S4 between the protective plate 30 and the edge of the opening 20 of the design bezel 2 to be small and to allow the cover sheet metal 31 to be in contact with the ribs 22 as illustrated in FIG. 15. In the case where the dimensions are designed to allow the gap S4 to be small, it is necessary to widen the distance between the cover sheet metal 31 and the ribs 22 in consideration of variations in the distance W. Thus, it is impossible to assemble so that the cover sheet metal 31 and the ribs 22 come into contact with each other. To the contrary, in the case where the dimensions are designed to allow the cover sheet metal 31 and the ribs 22 to come into contact with each other, the opening 20 of the design bezel 2 is required to have larger dimensions with respect to the protective plate 30 in consideration of variations in the distance W. Thus, it is impossible for the gap S4 to be small.

Therefore, in the second embodiment, the display panel 3A and the backlight 3B are not modularized into a display module, but are assembled to the design bezel 2 as separate members.

FIG. 16 is an exploded perspective view of a display apparatus 1a according to the second embodiment. The display apparatus 1a includes the design bezel 2, the display panel 3A provided behind the design bezel 2, and the backlight 3B provided behind the display panel 3A. Since the display panel 3A and the backlight 3B are not modularized, the cover sheet metal 31 is unnecessary.

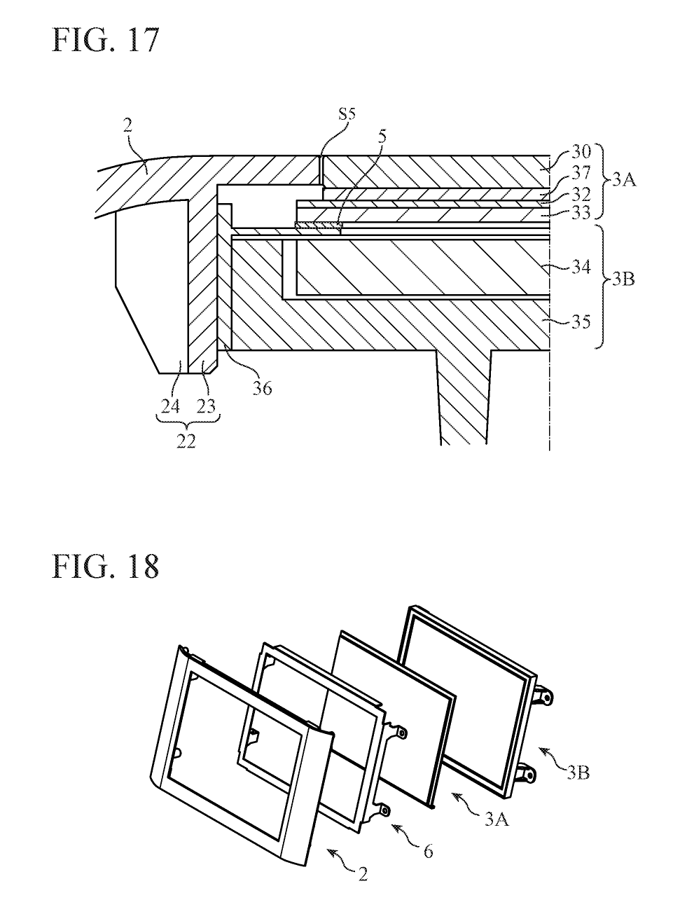

FIG. 17 is a cross-sectional view of the display apparatus 1a. Since the display panel 3A and the backlight 3B are not modularized, the backlight 3B is assembled after the display panel 3A is provisionally provided in the design bezel 2. Therefore, the display panel 3A is first provided so that a gap S5 between the protective plate 30 and the edge of the opening 20 of the design bezel 2 is small, and then the backlight 3B can be assembled so that the resin frame 36 is in contact with the ribs 22 and thereby lightly press-fitted. As described above, before the display apparatus 1a is assembled, the mutual position of the display panel 3A and the backlight 3B is not fixed. When the display apparatus 1a is assembled, the lightly press-fitted backlight 3B is fixed with respect to the display panel 3A via the design bezel 2.

As a result, the metal member 35, having rigidity that prevents deformation even when the metal member 35 receives a force in the shrinking direction from the design bezel 2 and a linear expansion coefficient that is smaller than the linear expansion coefficient of the design bezel 2, is sandwiched between the ribs 22 at the sides of the metal member 35 via the resin frame 36, thus allowing the metal member 35 to function as a shrinkage suppressing member that suppresses shrinkage of the design bezel 2.

In this manner, by utilizing the metal member 35 included in the backlight 3B, similar effects to those of the first embodiment can be obtained. In addition, it is facilitated to assemble in such a manner as to allow the gap S4 between the protective plate 30 and the edge of the opening 20 of the design bezel 2 to be small and to allow the cover sheet metal 31 to be in contact with the ribs 22.

Note that a cushion 5 made of urethane, for example, is attached to the back surface of the display panel 3A along the edge. With the cushion 5 sandwiched between the display panel 3A and the backlight 3B, it becomes unlikely for foreign matter to enter between the display panel 3A and the backlight 3B. The cushion 5 may be attached to the front surface of the backlight 3B instead of the back surface of the display panel 3A.

Moreover, the position of the display panel 3A is not fixed with respect to the backlight 3B before being assembled into the display apparatus 1a. Therefore, when the display panel 3A is assembled into the display apparatus 1a, the relative position of the display panel 3A may be misaligned as viewed from the backlight 3B. In consideration of this positional misalignment, it is preferable that the backlight 3B illuminates a wide area so as to be able to illuminate an area in which the display panel 3A may be provided.

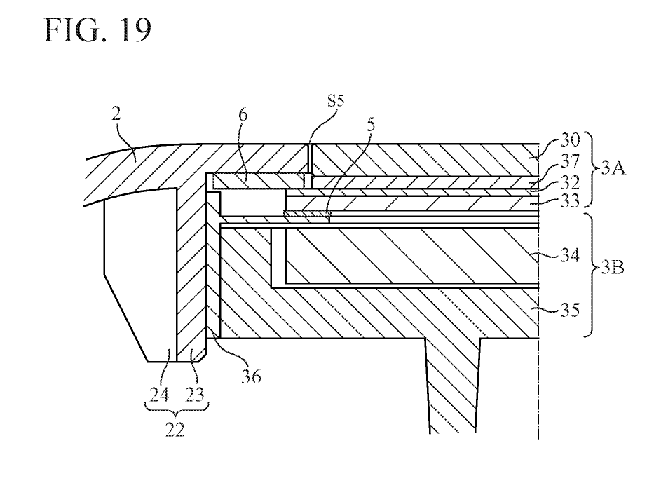

Meanwhile, as illustrated in an exploded perspective view of FIG. 18 and a cross sectional view of FIG. 19, a front bezel 6 made of metal may be provided between the design bezel 2 and the display panel 3A. The front bezel 6 can serve as an electrostatic countermeasure equivalent to the cover sheet metal 31. By being sandwiched between the front bezel 6 and the backlight 3B, the display panel 3A is held while further ensured to be free from rattling at the gap S5 between the protective plate 30 and the edge of the opening 20 of the design bezel 2. Note that in the case of the structure illustrated in FIG. 17, by allowing the design bezel 2 to be thick up to the position of the front bezel 6 illustrated in FIG. 19, the display panel 3A can be held while further ensured to be free from rattling like in the case where the front bezel 6 is provided.

In addition, as illustrated in FIG. 18, at the four corners of the front bezel 6, side walls are not formed in order to allow the metal member 35 to be in contact with the ribs 22 via the resin frame 36.

As described above, according to the display apparatus 1a of the second embodiment of the present invention, the ribs 22 are provided on the back surface of the design bezel 2, and the metal member 35, having rigidity that prevents deformation even when the metal member 35 receives a force in the shrinking direction from the design bezel 2 and a linear expansion coefficient that is smaller than the linear expansion coefficient of the design bezel 2, is sandwiched between the ribs 22 at the sides of the metal member 35. Therefore, similar effects to those of the first embodiment can be obtained by utilizing the metal member 35 of the backlight 3B.

In addition, the backlight 3B is fixed with respect to the display panel 3A via the design bezel 2. This facilitates assembling in such a manner as to allow the gap S4 between the protective plate 30 and the edge of the opening 20 of the design bezel 2 to be small and to allow the cover sheet metal 31 to be in contact with the ribs 22.

Furthermore, each of the ribs 22 is provided around the corresponding one of the four corners of the opening 20 having a rectangular shape in a plan view, and the metal member 35 serving as a shrinkage suppressing member is sandwiched between the ribs 22 at the sides of the four corners of the metal member 35. By providing the ribs 22 at positions where a particularly large stress is generated, it is possible to effectively prevent cracks from occurring.

In addition, the backlight 3B illuminates an area in which the display panel 3A may be provided. As a result, the display panel 3A is more easily illuminated uniformly.

Furthermore, the front bezel 6 made of metal is provided between the design bezel 2 and the display panel 3A. With the front bezel 6, an electrostatic countermeasure can be put in place.

Note that, within the scope of the present invention, the present invention may include a flexible combination of the embodiments, a modification of any component of the embodiments, or an omission of any component in the embodiments.

### INDUSTRIAL APPLICABILITY

As described above, the display apparatus according to the present invention is less prone to cracks on the front surface of the design bezel, and therefore is suitable for use as, for example, an in-vehicle display apparatus.

### REFERENCE SIGNS LIST

1: Display apparatus, 1a: Display apparatus, 2: Design bezel, 3: Display module, 3A: Display panel, 3B: Backlight, 4: Shrinkage suppressing member, 5: Cushion, 6: Front bezel, 20: Opening, 21: Frame main body, 22: Rib, 23: Abutment wall, 24: Support wall, 25: Thin rib, 30: Protective plate, 31: Cover sheet metal, 32: Touch panel, 33: Liquid crystal panel, 34: Optical member, 35: Metal member, 36: Resin frame, 37: Transparent adhesive layer, 38: Rib, 40: Space, 100: Display apparatus, 200: Design bezel

1. A display apparatus comprising:
a design bezel including an opening which penetrates through a front surface and a back surface of the design bezel and one or more ribs raised from the back surface around the opening;
a display module including a protective plate provided in the opening, the display module provided behind the design bezel; and
a shrinkage suppressing member provided behind the display module,
wherein the shrinkage suppressing member is sandwiched between the ribs at sides of the shrinkage suppressing member, and has rigidity that prevents deformation even when the shrinkage suppressing member receives a force in a shrinking direction from the design bezel and a linear expansion coefficient smaller than a linear expansion coefficient of the design bezel.

2. A display apparatus comprising:
a design bezel including an opening which penetrates through a front surface and a back surface of the design bezel and one or more ribs raised from the back surface around the opening;
a display panel including a protective plate provided in the opening, the display panel provided behind the design bezel; and
a backlight provided behind the display panel,
wherein the backlight includes a shrinkage suppressing member which is sandwiched between the ribs at sides of the shrinkage suppressing member and which has rigidity that prevents deformation even when the shrinkage suppressing member receives a force in a shrinking direction from the design bezel and a linear expansion coefficient smaller than a linear expansion coefficient of the design bezel.

3. The display apparatus according to claim 2, wherein the backlight is fixed with respect to the display panel via the design bezel.

4. The display apparatus according to claim 1,
wherein each of the ribs is provided around a corresponding one of four corners of the opening having a rectangular shape in a plan view, and
the shrinkage suppressing member is sandwiched between the ribs at sides of four corners of the shrinkage suppressing member.

5. The display apparatus according to claim 2,
wherein each of the ribs is provided around a corresponding one of four corners of the opening having a rectangular shape in a plan view, and
the shrinkage suppressing member is sandwiched between the ribs at sides of four corners of the shrinkage suppressing member.

6. The display apparatus according to claim 3, wherein the backlight illuminates an area in which the display panel is provided.

7. The display apparatus according to claim 3, wherein a front bezel made of metal is provided between the design bezel and the display panel.
